(19) United States
(12) Patent Application Publication
(10) Pub. No.: US 2016/0328061 A1
(43) Pub. Date: Nov. 10, 2016

(54) IN-CELL TOUCH PANEL

(71) Applicant: Raydium Semiconductor Corporation, Hsinchu (TW)

(72) Inventors: Chang-Ching CHIANG, Taichung City (TW); Yi-Ying Lin, Hualien City (TW); Kun-Pei LEE, Zhunan Township (TW)

(21) Appl. No.: 15/063,163

(22) Filed: Mar. 7, 2016

Related U.S. Application Data
(63) Continuation-in-part of application No. 14/882,880, filed on Oct. 14, 2015.
(60) Provisional application No. 62/162,238, filed on May 15, 2015.
(60) Provisional application No. 62/158,322, filed on May 7, 2015.

(51) Int. Cl. G06F 3/041; G06F 3/044

(52) U.S. Cl. CPC G06F 3/0412; G06F 3/044

(57) ABSTRACT

An in-cell touch panel is disclosed. The in-cell touch panel includes a plurality of pixels. Each pixel has a laminated structure bottom-up including a substrate, a TFT layer, a liquid crystal layer, a color filter layer, and a glass layer. The TFT layer is disposed on the substrate. A first conductive layer and a common electrode are disposed in the TFT layer. The first conductive layer is arranged in mesh type. The liquid crystal layer is disposed on the TFT layer. The color filter layer is disposed on the liquid crystal layer. The glass layer is disposed on the color filter layer. The design of touch electrodes and their trace layout in the in-cell touch panel of the application is simple and it can effectively reduce cost and reduce the RC loading of the common electrode.

### BACKGROUND OF THE INVENTION

1. Field of the Invention

This invention relates to a touch panel, especially to an in-cell touch panel having lower RC loading.

2. Description of the Related Art

In general, there are several different laminated structures of the capacitive touch panel; for example, an in-cell capacitive touch panel or an on-cell capacitive touch panel.

Please refer to FIG. 1 and FIG. 2. FIG. 1 and FIG. 2 illustrate two different laminated structures of the in-cell capacitive touch panel and the on-cell capacitive touch panel respectively. As shown in FIG. 1, the laminated structure 1 of the on-cell capacitive touch panel includes a substrate 10, a thin-film transistor layer 11, a liquid crystal layer 12, a color filtering layer 13, a glass layer 14, a touch sensing layer 15, a polarizer 16, an adhesive 17 and top lens 18. As shown in FIG. 2, the laminated structure 2 of the in-cell capacitive touch panel includes a substrate 20, a thin-film transistor layer 21, a touch sensing layer 22, a liquid crystal layer 23, a color filtering layer 24, a glass layer 25, a polarizer 26, an adhesive 27 and top lens 28.

After comparing FIG. 1 with FIG. 2, it can be found that the touch sensing layer 22 of the in-cell capacitive touch panel is disposed under the liquid crystal layer 23; that is to say, the touch sensing layer 22 is disposed in the liquid crystal display module of the in-cell capacitive touch panel. On the other hand, the touch sensing layer 15 of the on-cell capacitive touch panel is disposed above the glass layer 14; that is to say, the touch sensing layer 15 is disposed out of the liquid crystal display module of the on-cell capacitive touch panel. Compared to the conventional one glass solution (OGS) and on-cell capacitive touch panel, the in-cell capacitive touch panel can achieve thinnest touch panel design and widely used in portable electronic products such as mobile phones, tablet PCs, and notebooks.

Therefore, the invention provides an in-cell touch panel to reduce the effects of resistance and parasitic capacitance through its novel layout to enhance the entire performance of the in-cell touch panel.

### SUMMARY OF THE INVENTION

A preferred embodiment of the invention is an in-cell touch panel. In this embodiment, the in-cell touch panel includes a plurality of pixels. A laminated structure of each pixel includes a substrate, a thin-film transistor (TFT) layer, a liquid crystal layer, a color filtering layer, and a glass layer. The TFT layer is disposed above the substrate. A first conductive layer and a common electrode are disposed in the TFT layer, and the first conductive layer is arranged in mesh type. The liquid crystal layer is disposed above the TFT layer. The color filtering layer is disposed above the liquid crystal layer. The glass layer is disposed above the color filtering layer.

In an embodiment, the in-cell touch panel is an in-cell self-capacitive touch panel, and touch electrodes of the in-cell self-capacitive touch panel are formed by the first conductive layer arranged in mesh type.

In an embodiment, the first conductive layer and the common electrode are separated by an insulating layer.

In an embodiment, the touch electrodes are not connected with each other and there is a specific distance between the touch electrodes.

In an embodiment, the specific distance is an integral multiple of pixel or sub-pixel.

In an embodiment, a part of the first conductive layer not forming the touch electrodes is electrically connected with the common electrode through a via.

In an embodiment, the first conductive layer is formed after the common electrode.

In an embodiment, the first conductive layer is formed before the common electrode.

In an embodiment, the color filtering layer includes a color filter and a black matrix resist and the black matrix resist has good light resistance, and the first conductive layer is disposed under the black matrix resist.

In an embodiment, the first conductive layer overlaps a source line in the TFT layer.

In an embodiment, a touch mode and a display mode of the in-cell touch panel are driven in a time-sharing way, and the in-cell touch panel is operated in the touch mode during a blanking interval of a display period of the in-cell touch panel.

In an embodiment, when the in-cell touch panel is operated in the display mode, the common electrode is maintained a DC voltage or an AC voltage, and the touch electrodes are maintained a DC voltage, an AC voltage or a voltage related to the common electrode or the touch electrodes are in a floating state.

In an embodiment, the common electrode has a common electrode region overlapping the touch electrodes, when the in-cell touch panel is operated in the touch mode, the touch electrodes are provided a touch sensing signal and the common electrode is provided a touch-related signal having same frequency, same amplitude and same phase with the touch sensing signal.

In an embodiment, the common electrode has a common electrode region overlapping the touch electrodes, when the in-cell touch panel is operated in the touch mode, the touch electrodes are provided a touch sensing signal and the common electrode is disconnected with a signal source or in a floating state.

In an embodiment, the common electrode has common electrode regions overlapping the touch electrodes respectively, when the in-cell touch panel is operated in the touch mode, the touch electrodes are provided touch sensing signals and the common electrode regions are correspondingly provided touch-related signals having same frequency, same amplitude and same phase with the touch sensing signals in order, or the common electrode regions are correspondingly disconnected with a signal source or in a floating state in order.

In an embodiment, the common electrode has a common electrode region overlapping the touch electrodes, when the in-cell touch panel is operated in the touch mode, the touch electrodes are provided a touch sensing signal and a source line or a gate line in the thin-film transistor layer is provided a touch-related signal having same frequency, same amplitude and same phase with the touch sensing signal.

In an embodiment, the common electrode has common electrode regions overlapping the touch electrodes respectively, when the in-cell touch panel is operated in the touch mode, the touch electrodes are provided touch sensing signals in order and a source line or a gate line in the thin-film transistor layer is correspondingly provided touch-related signals having same frequency, same amplitude and same phase with the touch sensing signals in order.

In an embodiment, a second conductive layer is disposed in the thin-film transistor layer and the second conductive layer is electrically connected with the first conductive layer.

In an embodiment, the second conductive layer and a source electrode and a drain electrode of the thin-film transistor layer are formed simultaneously.

In an embodiment, the second conductive layer and the first conductive layer are overlapped and coupled in parallel.

In an embodiment, the second conductive layer forms a bridge structure through a via to across the first conductive layer.

In an embodiment, when the laminated structure has a half source driving (HSD) structure, the laminated structure has an additional space which is originally occupied by a source line, and the second conductive layer electrically connected with the first conductive layer is disposed in the additional space as traces of the touch electrodes.

In an embodiment, the second conductive layer not used as traces or signal lines is electrically connected with the first conductive layer not used as touch electrodes through a via and further electrically connected with the common electrode through the via to enhance a conductivity of the common electrode.

In an embodiment, driving times of a touch mode and a display mode of the in-cell touch panel are at least partially overlapped.

In an embodiment, when the in-cell touch panel is operated in the touch mode, the touch electrodes are provided a touch sensing signal, the common electrode or a source line is in a floating state in a part of time and provided a touch-related signal having same frequency, same amplitude and same phase with the touch sensing signal in another part of time.

Compared to the prior arts, the in-cell touch panel and its trace layout of the invention have following advantages:

(1) The laminated structure of the in-cell touch panel of the invention is simple and easy to be manufactured to reduce costs.

(2) Designs of the touch electrodes, common electrodes and their traces in the in-cell touch panel of the invention are very simple.

(3) The aperture ratio of the LCD touch panel will not be affected by the novel trace layout method of the invention.

(4) The RC loading of the common electrode can be effectively reduced.

(5) When the in-cell touch panel is operated in the touch mode, the common electrode is controlled simultaneously to reduce the entire RC loading of the in-cell touch panel.

The advantage and spirit of the invention may be understood by the following detailed descriptions together with the appended drawings.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 and FIG. 2 illustrate schematic diagrams of the laminated structure of the conventional in-cell capacitive touch panel and on-cell capacitive touch panel respectively.

FIG. 3A, FIG. 3B, FIG. 3C and FIG. 3D illustrate schematic diagrams of the laminated structures of the in-cell self-capacitive touch panel in different embodiments of the invention respectively.

FIG. 4A illustrates a schematic diagram of the touch electrodes of the in-cell self-capacitive touch panel and their traces.

FIG. 4B illustrates a schematic diagram of a part of first conductive layer not used as touch electrode electrically connecting with the common electrode through the via.

FIG. 5A illustrates a schematic diagram of the common electrode having a common electrode region overlapping the first touch electrode, the second touch electrode and the third touch electrode.

FIG. 5B, FIG. 5C and FIG. 5D illustrate timing diagrams of the signals of the in-cell self-capacitive touch panel operated in the display mode and touch mode in different embodiments of the invention.

FIG. 6A illustrates a schematic diagram of the common electrode having common electrode regions overlapping the first touch electrode, the second touch electrode and the third touch electrode respectively.

FIG. 6B illustrates a timing diagram of the signals of the in-cell self-capacitive touch panel of FIG. 6A operated in the display mode and touch mode.

FIG. 7A illustrates a schematic diagram of the second conductive layer electrically connecting with the first conductive layer through the via in the laminated structures of the in-cell self-capacitive touch panel.

FIG. 7B illustrates a schematic diagram of the second conductive layer electrically connecting with the first conductive layer through the via and further electrically connecting with the common electrode through the via in the laminated structures of the in-cell self-capacitive touch panel.

FIG. 7C illustrates an embodiment of the pixel design in the in-cell self-capacitive touch panel.

FIG. 8 illustrates a schematic diagram of the traces formed by the second conductive layer and the signal lines are interlaced and different touch electrodes are bridged by the via through the traces in the in-cell self-capacitive touch panel.

FIG. 9A, FIG. 9B and FIG. 9C illustrate schematic diagrams of the touch electrodes having different shapes formed by the first conductive layer aligned in mesh-type.

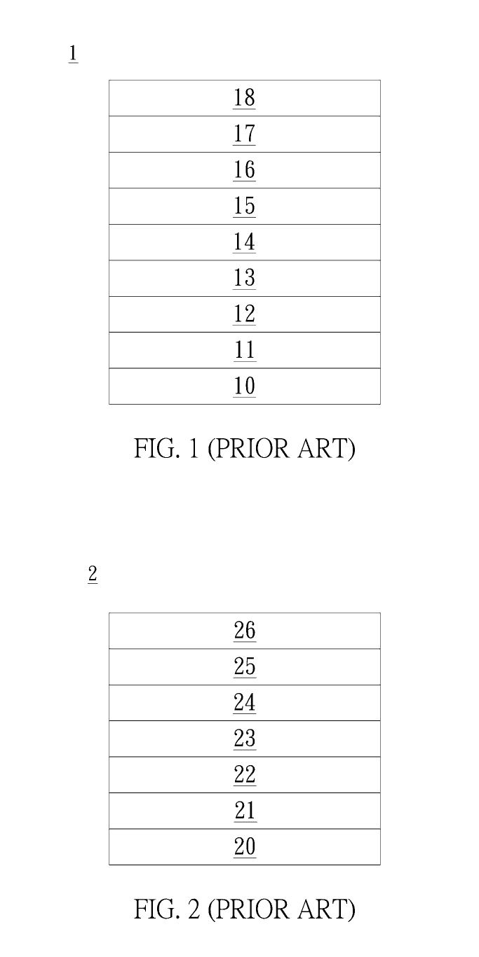

### DETAILED DESCRIPTION

A preferred embodiment of the invention is an in-cell capacitive touch panel. In practical applications, the in-cell capacitive touch panel can achieve thinnest touch panel design; therefore, it can be widely used in portable electronic products such as mobile phones, tablet PCs, and notebooks.

In this embodiment, the in-cell capacitive touch panel can be suitable for displays using in-plane switching liquid crystal (IPS) technology, fringe field switching (FFS) technology, or advanced hyper-viewing angle (AHVA) technology, but not limited to these cases.

In general, the most popular capacitive touch sensing technology in nowadays should be the projected capacitive touch sensing technology including a mutual-capacitive type and a self-capacitive type. As to the mutual-capacitive touch sensing technology, when a touch occurs, capacitive coupling will be generated between two electrode layers adjacent to the touch point, and the capacitance change between the two electrode layers will be used to determine the touch point. As to the self-capacitive touch sensing technology, when a touch occurs, capacitive coupling will be generated between the touch item and the electrode, and the capacitance change of the electrode will be used to determine the touch point.

It should be noted that the self-capacitive touch sensing technology can be used in the in-cell capacitive touch panel of this embodiment. The touch electrodes of the in-cell capacitive touch panel are formed by the first conductive layer arranged in mesh type, and it provides novel layout method to reduce the electrical and optical effects caused by the in-cell touch elements of the in-cell capacitive touch panel.

Next, the laminated structure of the in-cell self-capacitive touch panel in this embodiment will be introduced as follows.

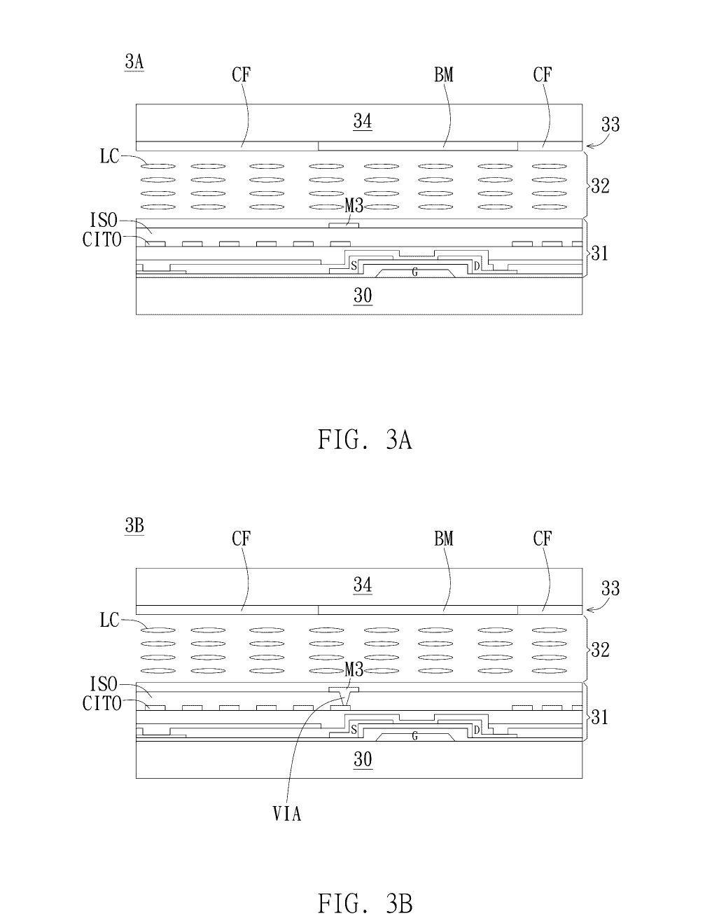

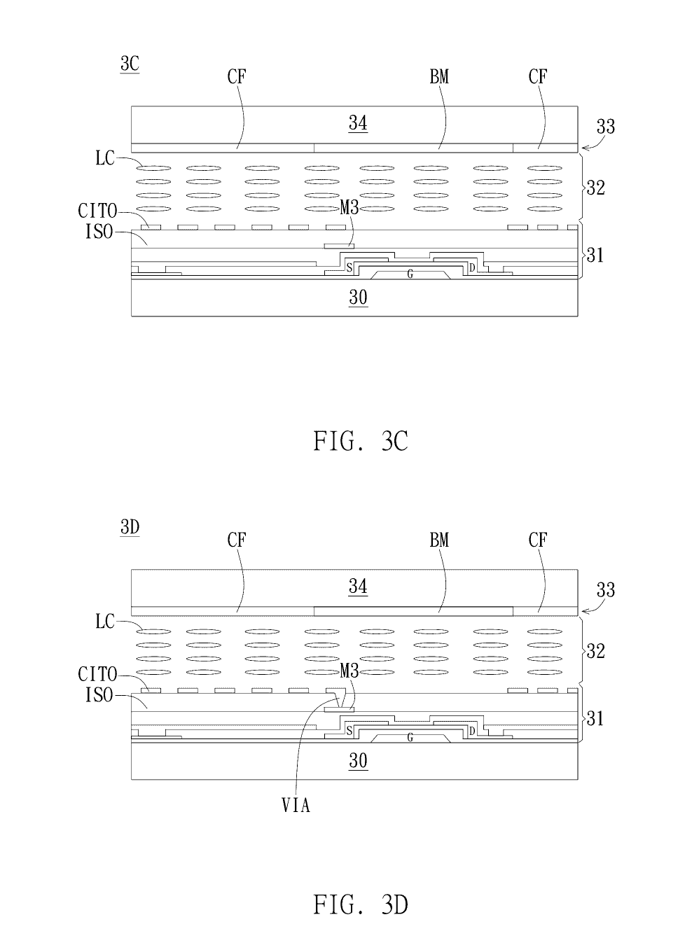

As shown in FIG. 3A, in an embodiment, the laminated structure 3A of the in-cell self-capacitive touch panel includes a substrate 30, a thin-film transistor (TFT) layer 31, a liquid crystal layer 32, a color filtering layer 33, a glass layer 34.

The TFT layer 31 is disposed above the substrate 30. A first conductive layer M3 and a common electrode CITO are disposed in the TFT layer 31. The first conductive layer 31 is arranged in mesh type. The liquid crystal layer 32 including liquid crystal units LC is disposed above the TFT layer 31. The color filtering layer 33 is disposed above the liquid crystal layer 32. The glass layer 34 is disposed above the color filtering layer 33.

In fact, the first conductive layer M3 can be formed by metal or any other conductive material; the common electrode CITO can be formed by an indium tin oxide (ITO) layer, but not limited to this.

The color filtering layer 33 includes a color filter CF and a black matrix resist BM. The black matrix resist BM has good light resistance and it can be used in the color filtering layer 33 to separate three different color filters including a red (R) color filter, a green (G) color filter, and a blue (b) color filter, but not limited to this. In this embodiment, the first conductive layer M3 arranged in mesh type is disposed under the black matrix resist BM and shielded by the black matrix resist BM.

It should be noticed that, in the laminated structure 3A of the in-cell self-capacitive touch panel shown in FIG. 3A, the first conductive layer M3 is formed after the common electrode CITO; the first conductive layer M3 and the common electrode CITO are separated by an insulating layer ISO, and the first conductive layer M3 cannot be electrically connected with the common electrode CITO.

In another embodiment, in the laminated structure 3B of the in-cell self-capacitive touch panel shown in FIG. 3B, the first conductive layer M3 is also formed after the common electrode CITO; the first conductive layer M3 and the common electrode CITO are separated by the insulating layer ISO, but the first conductive layer M3 can be electrically connected with the common electrode CITO through a via VIA.

In addition, in the laminated structure 3C of the in-cell self-capacitive touch panel shown in FIG. 3C, the first conductive layer M3 is formed before the common electrode CITO; the first conductive layer M3 and the common electrode CITO are separated by an insulating layer ISO, so that the common electrode CITO will not be electrically connected with the first conductive layer M3.

In another embodiment, in the laminated structure 3D of the in-cell self-capacitive touch panel shown in FIG. 3D, the first conductive layer M3 is also formed before the common electrode CITO; the first conductive layer M3 and the common electrode CITO are separated by an insulating layer ISO; the common electrode CITO is electrically connected with the first conductive layer M3 through a via VIA.

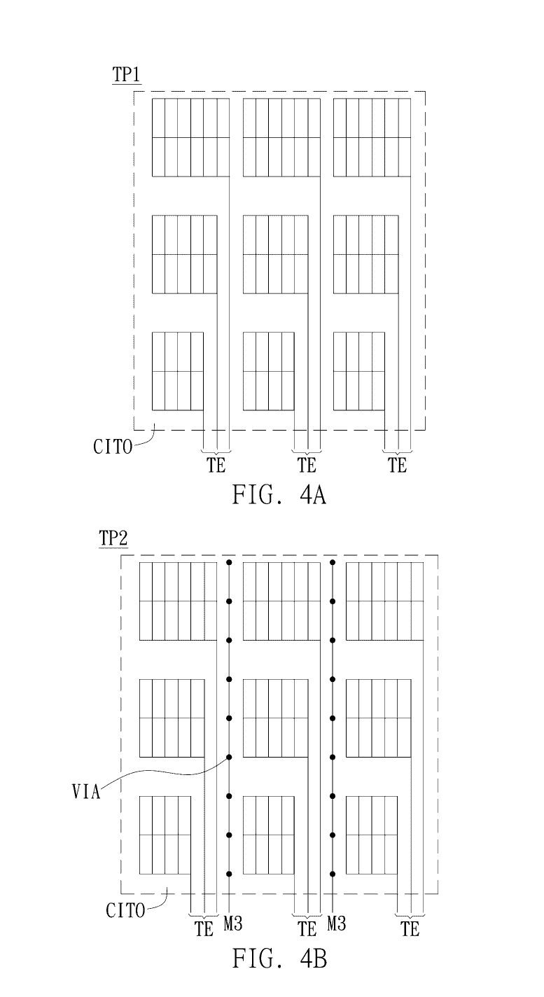

Then, as shown in FIG. 4, touch electrodes TE of the in-cell self-capacitive touch panel TP1 are formed by the first conductive layer M3 arranged in mesh type; the touch electrodes TE are not connected and there is a specific distance between the touch electrodes TE. The touch electrodes TE and the common electrode CITO are not connected. In fact, the specific distance can be an integral multiple of pixel or sub-pixel, but not limited to this.

In addition, as shown in FIG. 4B, in the in-cell self-capacitive touch panel TP2, a part of the first conductive layer M3 not forming the touch electrodes TE can be electrically connected with the common electrode CITO through the via VIA to be traces of the common electrode CITO. It should be noted that the touch electrodes TE in FIG. 4B are also formed by the first conductive layer M3, but the first conductive layer M3 used as the touch electrodes TE and their traces will not be electrically connected with the common electrode CITO. A part of the first conductive layer M3 not forming the touch electrodes TE can be electrically connected with the common electrode CITO through the via VIA to be traces of the common electrode CITO.

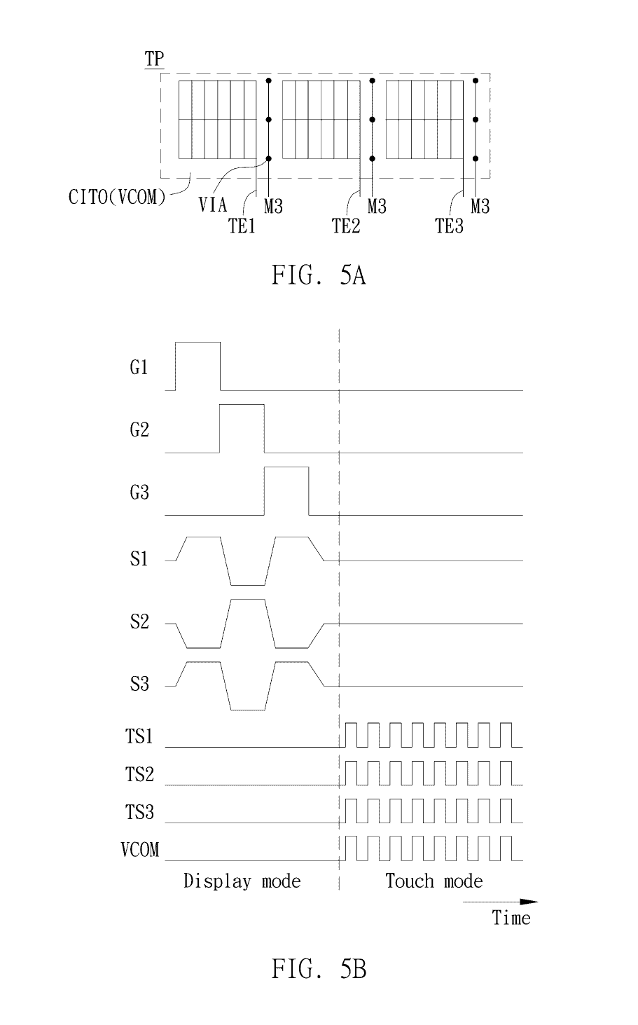

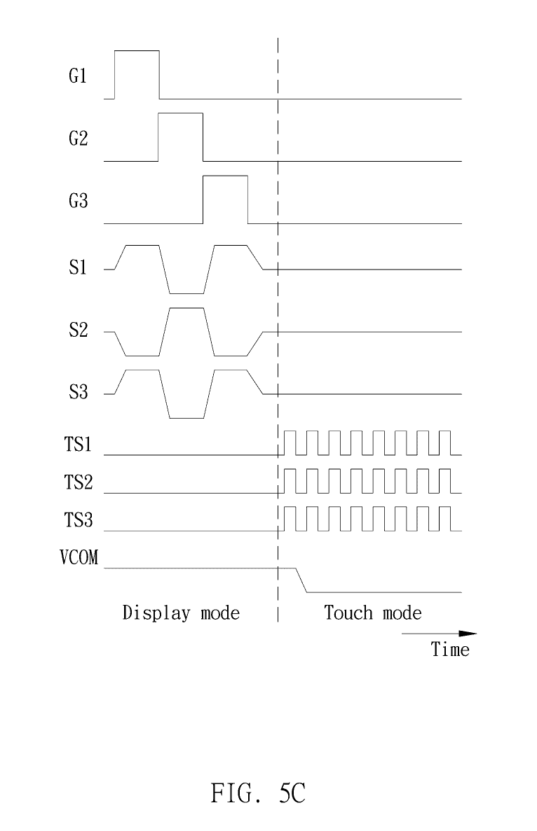

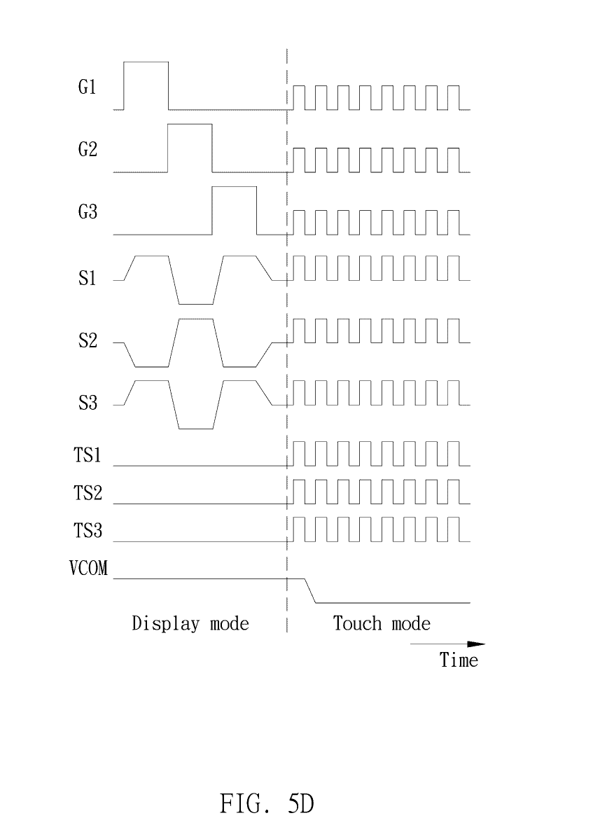

Then, please refer to FIG. 5A. In the in-cell self-capacitive touch panel TP, the first conductive layer M3 arranged in mesh type forms the first touch electrode TE1, the second touch electrode TE2 and the third touch electrode TE3 respectively; the common electrode CITO has a common electrode region VCOM overlapping the first touch electrode TE1, the second touch electrode TE2 and the third touch electrode TE3, but the first touch electrode TE1, the second touch electrode TE2 and the third touch electrode TE3 are not electrically connected with the common electrode CITO. A part of the first conductive layer M3 not forming the touch electrodes TE can be electrically connected with the common electrode CITO through the via VIA to be traces of the common electrode CITO disposed among the first touch electrode TE1, the second touch electrode TE2 and the third touch electrode TE3 respectively.

It should be noticed that a touch mode and a display mode of the in-cell self-capacitive touch panel TP of the invention can be driven in a time-sharing way, and the in-cell self-capacitive touch panel TP can be operated in the touch mode during a blanking interval of a display period of the in-cell self-capacitive touch panel TP, but not limited to this. In fact, the driving times of the touch mode and the display mode of the in-cell self-capacitive touch panel TP of the invention can be at least partially overlapped.

In an embodiment, as shown in FIG. 5B, when the in-cell self-capacitive touch panel TP is operated in the display mode, the common electrode region VCOM can be maintained a DC voltage or an AC voltage, and the first touch electrode TE1, the second touch electrode TE2 and the third touch electrode TE3 are maintained a DC voltage, an AC voltage or a voltage related to the common electrode region VCOM or the first touch electrode TE1, the second touch electrode TE2 and the third touch electrode TE3 are in a floating state. When the in-cell self-capacitive touch panel TP is operated in the touch mode, the first touch electrode TE1, the second touch electrode TE2 and the third touch electrode TE3 are provided touch sensing signals TS1-TS3 and the common electrode region VCOM is provided a touch-related signal having same frequency, same amplitude and same phase with the touch sensing signals TS1-TS3.

In another embodiment, as shown in FIG. 5C, when the in-cell self-capacitive touch panel TP is operated in the touch mode, the first touch electrode TE1, the second touch electrode TE2 and the third touch electrode TE3 are provided touch sensing signals TS1-TS3, but the common electrode region VCOM is disconnected with a signal source or in a floating state.

In another embodiment, as shown in FIG. 5D, when the in-cell self-capacitive touch panel TP is operated in the touch mode, the first touch electrode TE1, the second touch electrode TE2 and the third touch electrode TE3 are provided touch sensing signals TS1-TS3, but the source lines S1-S3 and gate lines G1-G3 in the TFT layer are provided a touch-related signal having same frequency, same amplitude and same phase with the touch sensing signals TS1-TS3.

Except the above-mentioned embodiments, the common electrode CITO can have common electrode regions overlapping different touch electrodes respectively.

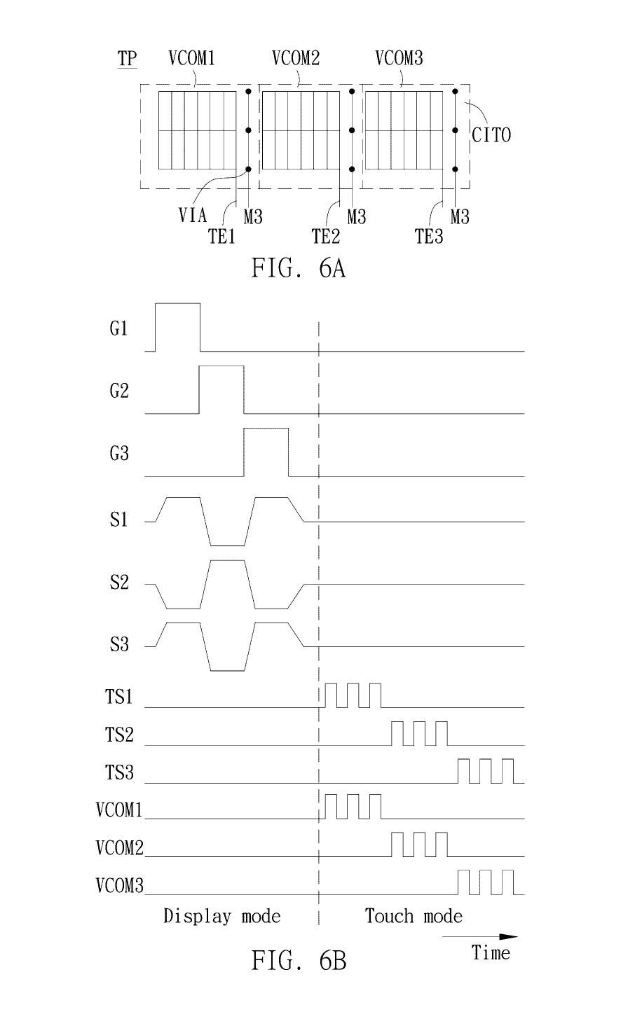

Please refer to FIG. 6A. As shown in FIG. 6A, the common electrode CITO has the first common electrode region VCOM1, the second common electrode region VCOM2 and the third common electrode region VCOM3 overlapping the first touch electrode TE1, the second touch electrode TE2 and the third touch electrode TE3 respectively.

When the in-cell self-capacitive touch panel TP is operated in the touch mode, the first touch electrode TE1, the second touch electrode TE2 and the third touch electrode TE3 are provided the first touch sensing signal TX1, the second touch sensing signal TX2 and the third touch sensing signal TX3 in order, and the first common electrode region VCOM1, the second common electrode region VCOM2 and the third common electrode region VCOM3 can be correspondingly provided touch-related signals having same frequency, same amplitude and same phase with the first touch sensing signal TX1, the second touch sensing signal TX2 and the third touch sensing signal TX3 in order. In another embodiment, the first common electrode region VCOM1, the second common electrode region VCOM2 and the third common electrode region VCOM3 can be correspondingly disconnected with a signal source or in a floating state in order.

It should be noticed that, in practical applications, when the in-cell self-capacitive touch panel TP is operated in the touch mode, the single common electrode region VCOM, the first common electrode region VCOM1, the second common electrode region VCOM2 and the third common electrode region VCOM3, or the source lines can be in a floating state in a part of time and provided a touch-related signal having same frequency, same amplitude and same phase with the touch sensing signal in another part of time, but not limited to this.

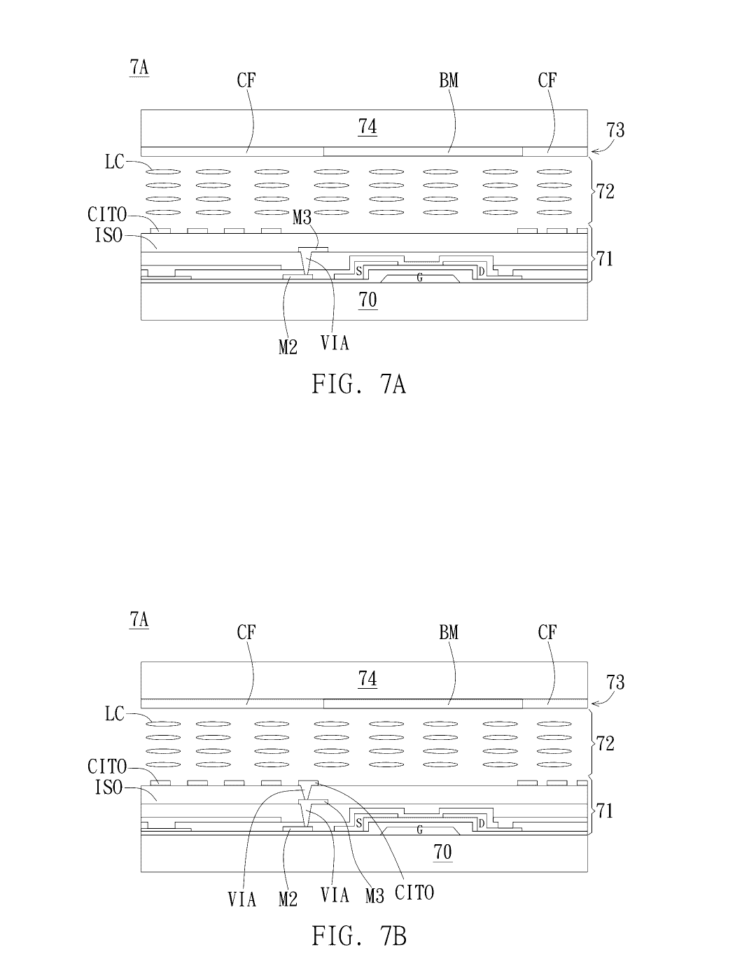

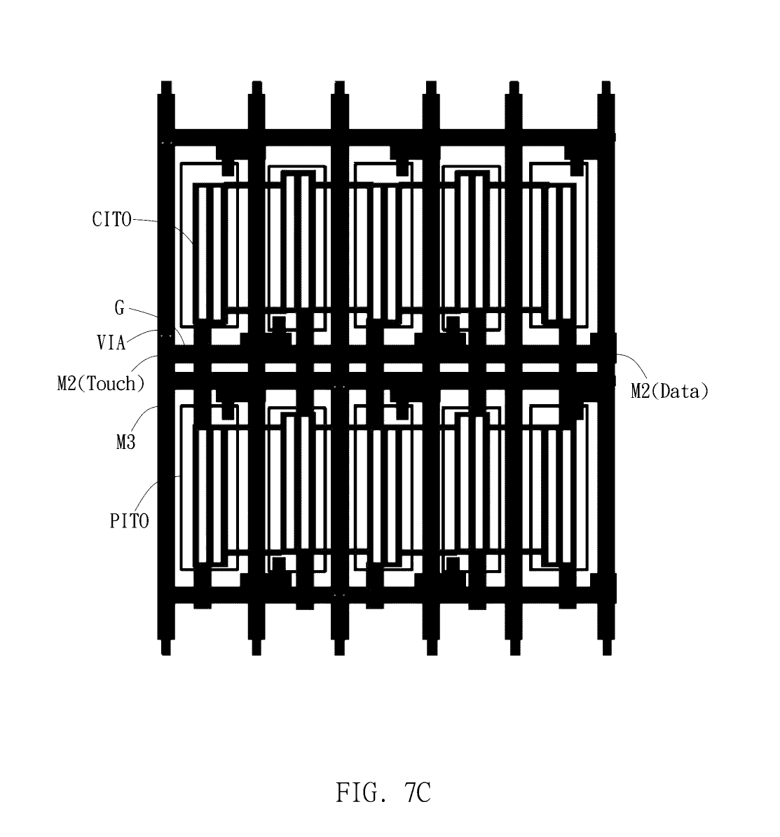

As shown in FIG. 7A, in another embodiment, in the laminated structure 7A of the in-cell self-capacitive touch panel, the second conductive layer M2 is disposed in the TFT layer 71 and the second conductive layer M2 is electrically connected with the first conductive layer M3 through the via VIA. In fact, the second conductive layer M2 and the source lines S and drain lines D in the TFT layer 71 can be formed at the same time; the first conductive layer M3 and the source lines S in the TFT layer 71 can be overlapped, but not limited to this. FIG. 7C illustrates an embodiment of the pixel design in the in-cell self-capacitive touch panel, but also not limited to this.

In practical applications, the second conductive layer M2 and the first conductive layer M3 can be overlapped and coupled in parallel; the second conductive layer M2 can form a bridge structure through the via VIA to across the first conductive layer M3, but not limited to this.

In practical applications, when the laminated structure of the in-cell self-capacitive touch panel has a half source driving (HSD) structure, the laminated structure will have an additional space which is originally occupied by a source line, and the second conductive layer M2 electrically connected with the first conductive layer M3 can be disposed in the additional space as the traces of the touch electrodes TE, but not limited to this.

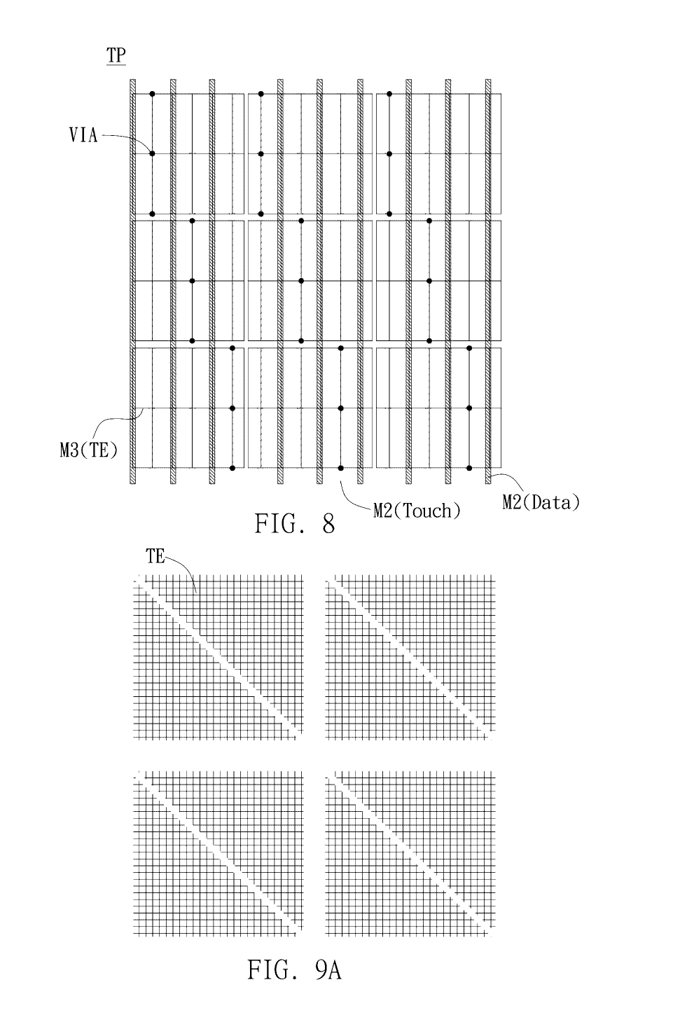

In this embodiment, as shown in FIG. 8, the traces M2(Touch) and the signal lines M2(Data) formed by the second conductive layer M2 are interlaced; therefore, the number of the second conductive layer M2 can be reduced by half. The second conductive layer M2 and the first conductive layer M3 can be overlapped completely, and different touch electrodes TE can be bridged by the via VIA through the traces M2(Touch); therefore, the touch electrodes TE formed by the first conductive layer M3 arranged in mesh type can cover larger area to reduce the area of the touch sensing dead zone, and the effective touch sensing area of the in-cell self-capacitive touch panel TP can be increased accordingly.

It should be noticed that, when the touch sensing is performed in this embodiment, the signal control of the common electrodes CITO, the source lines S and the gate lines G can be the same with any above-mentioned embodiments without any specific limitations. Furthermore, similar to the above-mentioned embodiments, the first conductive layer M3 not used as the touch electrodes can be also electrically connected with the common electrode CITO through the via VIA to increase the conductivity of the common electrode CITO. And, as shown in FIG. 7B, the second conductive layer M2 not used as traces or signal lines can be also electrically connected with the first conductive layer M3 not used as touch electrodes through the via VIA and further electrically connected with the common electrode CITO through the via VIA to further enhance the conductivity of the common electrode CITO.

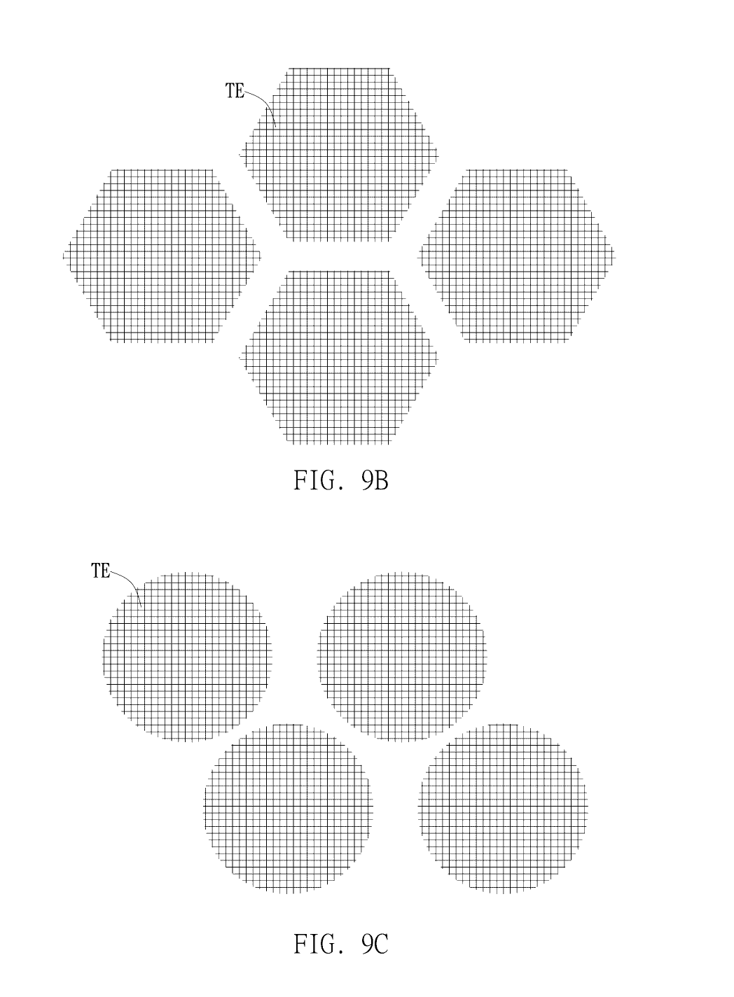

Please refer to FIG. 9A, FIG. 9B and FIG. 9C. As shown in FIG. 9A, FIG. 9B and FIG. 9C, the shapes of the touch electrodes TE formed by the first conductive layer M3 arranged in mesh type is not limited to the conventional rectangle or square, in practical applications, the shapes of the touch electrodes TE can be triangle (as shown in FIG. 9A), hexagonal (as shown in FIG. 9B), circular (as shown in FIG. 9C) or any other geometries without any specific limitations.

Compared to the prior arts, the in-cell touch panel and its trace layout of the invention have following advantages:

(1) The laminated structure of the in-cell touch panel of the invention is simple and easy to be manufactured to reduce costs.

(2) Designs of the touch electrodes, common electrodes and their traces in the in-cell touch panel of the invention are very simple.

(3) The aperture ratio of the LCD touch panel will not be affected by the novel trace layout method of the invention.

(4) The RC loading of the common electrode can be effectively reduced.

(5) When the in-cell touch panel is operated in the touch mode, the common electrode is controlled simultaneously to reduce the entire RC loading of the in-cell touch panel.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1. An in-cell touch panel, comprising:
a plurality of pixels, a laminated structure of each pixel comprising:
a substance;
a thin-film transistor layer disposed above the substrate, wherein a first conductive layer and a common electrode are disposed in the thin-film transistor layer, and the first conductive layer is arranged in mesh type;
a liquid crystal layer, disposed above the thin-film transistor layer;
a color filtering layer, disposed above the liquid crystal layer; and
a glass layer, disposed above the color filtering layer.

2. The in-cell touch panel of claim 1, wherein the in-cell touch panel is an in-cell self-capacitive touch panel, and touch electrodes of the in-cell self-capacitive touch panel are formed by the first conductive layer arranged in mesh type.

3. The in-cell touch panel of claim 2, wherein the first conductive layer and the common electrode are separated by an insulating layer.

4. The in-cell touch panel of claim 2, wherein the touch electrodes are not connected with each other and there is a specific distance between the touch electrodes.

5. The in-cell touch panel of claim 4, wherein the specific distance is an integral multiple of pixel or sub-pixel.

6. The in-cell touch panel of claim 2, wherein a part of the first conductive layer not forming the touch electrodes is electrically connected with the common electrode through a via.

7. The in-cell touch panel of claim 1, wherein the first conductive layer is formed after the common electrode.

8. The in-cell touch panel of claim 1, wherein the first conductive layer is formed before the common electrode.

9. The in-cell touch panel of claim 1, wherein the color filtering layer comprises a color filter and a black matrix resist and the black matrix resist has good light resistance, and the first conductive layer is disposed under the black matrix resist.

10. The in-cell touch panel of claim 1, wherein the first conductive layer overlaps a source line in the TFT layer.

11. The in-cell touch panel of claim 2, wherein a touch mode and a display mode of the in-cell touch panel are driven in a time-sharing way, and the in-cell touch panel is operated in the touch mode during a blanking interval of a display period of the in-cell touch panel.

12. The in-cell touch panel of claim 11, wherein when the in-cell touch panel is operated in the display mode, the common electrode is maintained a DC voltage or an AC voltage, and the touch electrodes are maintained a DC voltage, an AC voltage or a voltage related to the common electrode or the touch electrodes are in a floating state.

13. The in-cell touch panel of claim 11, wherein the common electrode has a common electrode region overlapping the touch electrodes, when the in-cell touch panel is operated in the touch mode, the touch electrodes are provided a touch sensing signal and the common electrode is provided a touch-related signal having same frequency, same amplitude and same phase with the touch sensing signal.

14. The in-cell touch panel of claim 11, wherein the common electrode has a common electrode region overlapping the touch electrodes, when the in-cell touch panel is operated in the touch mode, the touch electrodes are provided a touch sensing signal and the common electrode is disconnected with a signal source or in a floating state.

15. The in-cell touch panel of claim 11, wherein the common electrode has common electrode regions overlapping the touch electrodes respectively, when the in-cell touch panel is operated in the touch mode, the touch electrodes are provided touch sensing signals and the common electrode regions are correspondingly provided touch-related signals having same frequency, same amplitude and same phase with the touch sensing signals in order, or the common electrode regions are correspondingly disconnected with a signal source or in a floating state in order.

16. The in-cell touch panel of claim 11, wherein the common electrode has a common electrode region overlapping the touch electrodes, when the in-cell touch panel is operated in the touch mode, the touch electrodes are provided a touch sensing signal and a source line or a gate line in the thin-film transistor layer is provided a touch-related signal having same frequency, same amplitude and same phase with the touch sensing signal.

17. The in-cell touch panel of claim 11, wherein the common electrode has common electrode regions overlapping the touch electrodes respectively, when the in-cell touch panel is operated in the touch mode, the touch electrodes are provided touch sensing signals in order and a source line or a gate line in the thin-film transistor layer is correspondingly provided touch-related signals having same frequency, same amplitude and same phase with the touch sensing signals in order.

18. The in-cell touch panel of claim 1, wherein a second conductive layer is disposed in the thin-film transistor layer and the second conductive layer is electrically connected with the first conductive layer.

19. The in-cell touch panel of claim 18, wherein the second conductive layer and a source electrode and a drain electrode of the thin-film transistor layer are formed simultaneously.

20. The in-cell touch panel of claim 18, wherein the second conductive layer and the first conductive layer are overlapped and coupled in parallel.

21. The in-cell touch panel of claim 18, wherein the second conductive layer forms a bridge structure through a via to across the first conductive layer.

22. The in-cell touch panel of claim 18, wherein when the laminated structure has a half source driving (HSD) structure, the laminated structure has an additional space which is originally occupied by a source line, and the second conductive layer electrically connected with the first conductive layer is disposed in the additional space as traces of the touch electrodes.

23. The in-cell touch panel of claim 18, wherein the second conductive layer not used as traces or signal lines is electrically connected with the first conductive layer not used as touch electrodes through a via and further electrically connected with the common electrode through the via to enhance a conductivity of the common electrode.

24. The in-cell touch panel of claim 2, wherein driving times of a touch mode and a display mode of the in-cell touch panel are at least partially overlapped.

25. The in-cell touch panel of claim 11, wherein when the in-cell touch panel is operated in the touch mode, the touch electrodes are provided a touch sensing signal, the common electrode or a source line is in a floating state in a part of time and provided a touch-related signal having same frequency, same amplitude and same phase with the touch sensing signal in another part of time.
